(19) United States
(12) Patent Application Publication
(10) Pub. No.: US 2013/0019450 A1
(43) Pub. Date: Jan. 24, 2013

(54) Apparatus and Method for Fastening Credit Card Size Cards Together

(71) Applicant: Farrokh Rassouli, Maple Grove, MN (US)

(72) Inventor: Farrokh Rassouli, Maple Grove, MN (US)

(73) Assignee: HOLE CONCEPTS, INC., Maple Grove, MN (US)

(21) Appl. No.: 13/553,467

(22) Filed: Jul. 19, 2012

Related U.S. Application Data
(60) Provisional application No. 61/509,274, filed on Jul. 19, 2011.

(51) Int. Cl. A45C 11/00; F16C 11/04; B23P 11/00

(52) U.S. Cl. 29/428; 29/700; 24/595.1

(57) ABSTRACT

A kit and method for removably fastening together two or more credit card sized cards are disclosed. The fastener, removably extending through at least one hole in each one of the two or more credit card sized cards, is configured for permitting each one of the two or more credit card sized cards to rotate relative to one another for easily accessing any one of the cards. The fastener is further configured for being un-fastened or dis-assembled for adding one or more cards, removing one or more cards, shuffling or re-arranging the order of the cards, etc., and then removably re-fastened together using the same or a different sized (longer or shorter) fastener. In certain embodiment, a money clip is removably attached together with two or more cards.

### CROSS-REFERENCE TO RELATED APPLICATIONS

This application claims the benefit of U.S. Provisional Patent Application Ser. No. 61/509,274 filed Jul. 19, 2011 the entirety of which is hereby incorporated herein by reference.

### TECHNICAL FIELD

The present invention relates to fastening together two or more flat objects for ease and convenience of carrying and using the objects.

### BACKGROUND

People are constantly losing, misplacing or forgetting to bring needed credit cards, debit cards, identification cards, and especially gift and loyalty rewards cards. The use of wallets, money clips, purses, rubber band, etc. do not allow access to needed cards without having to sort through multiple plastic cards. People need a way to conveniently carry, organize and utilize their plastic cards, they need aids in prevention of losing or misplacing individual cards.

Accordingly, there exists a need for fastening together two or more such cards and/or similar flat objects for ease and convenience of carrying and using them.

### SUMMARY

An embodiment of the invention comprises a kit for removably fastening together two or more credit card sized cards. Some embodiments of the kit include a guide sleeve for removably receiving and temporarily holding one of the credit card sized cards and a hole punch for punching a hole through one of the two or more credit card sized cards or the guide sleeve. The kit further includes a fastener configured for removably fastening together the two or more credit card sized cards at holes created by the hole punch and permitting the two or more credit card sized cards to rotate relative to each other after they have been fastened together by the fastener. The fastener is configured for being un-fastened or dis-assembled for adding one or more cards, removing one or more cards, shuffling or re-arranging the order of the cards, etc., and then removably re-fastened together using the same or a different sized (longer or shorter) fastener.

An alternate embodiments of the kit includes a hole punch having alignment guides for removably receiving one of the credit card sized cards in a predetermined position and punching a hole through the credit card sized card received in the hole punch. The kit further includes a fastener configured for removably fastening together the two or more credit card sized cards at holes created by the hole punch and permitting the two or more credit card sized cards to rotate relative to each other after they have been fastened together by the fastener. In some embodiments of the invention, the hole punch is configured for concurrently punching two or more holes at predetermined positions through the credit card sized card received in the hole punch.

In accordance with an embodiment of the invention, a fastener for removably fastening together two or more credit card sized cards includes a first portion with a first connector portion, a second portion with a second connector portion. At least one of the first portion and the second portion is configured for being inserted through the holes in the two or more credit card sized cards, and the first and the second connector portions are configured for being removably connected together. The first and the second connector portions are further configured for removably fastening together the two or more credit card sized cards while permitting the two or more credit card sized cards to rotate relative to each other when the first and second connector portions are connected together and when the at least one of the first portion and the second portion is inserted through the hole in the two or more credit card sized cards. The fastener is configured for being un-fastened or dis-assembled for adding one or more cards, removing one or more cards, shuffling or re-arranging the order of the cards, etc., and then removably re-fastened together using the same or a different sized (longer or shorter) fastener. Accordingly, in some embodiments of the invention, the fastener includes a flanged threaded boss and a mating bolt. In other embodiments of the invention, the fastener is one or more of a carabiner, lanyard, hitch knot, etc., or any combination thereof.

In some embodiments of the invention, the kit includes one or more clips configured to function or operate as a money clip when removably fastened together with the two or more credit card sized cards.

A method of removably fastening together two or more credit card sized cards, in accordance with an embodiment of the invention, includes punching a hole in a guide sleeve configured for removably receiving and temporarily holding one of the credit card sized cards. The hole is punched at a location defined as the guide sleeve hole. Each one of the credit card sized cards is inserted in the guide sleeve, with only one card in the guide sleeve at any one time. Next, while the credit card sized card is in the guide sleeve, a hole is punched through the card at the guide sleeve location. The credit card sized card, having a hole punched therethrough, is removed from the guide sleeve. Additional credit card sized cards are inserted in the guide sleeve, one card at a time, and a hole is punched through the card while it is in the guide sleeve. Next, two or more credit card sized cards are fastened together using a fastener inserted through the holes punched in the cards. The fastener is configured to permit the two or more credit card sized cards to rotate relative to each other when fastened together by the fastener. The fastener is further configured for being un-fastened or dis-assembled for adding one or more cards, removing one or more cards, shuffling or re-arranging the order of the cards, etc., and then removably re-fastened together using the same or a different sized (longer or shorter) fastener.

In some embodiments of the invention, the method includes punching a second hole through the two or more credit card sized cards removably fastened together with the fastener. As such, the two or more credit card sized cards can be further removably fastened together using a second fastener, including one or more of a carabiner, lanyard, hitch knot, etc., or any combination thereof. In other embodiments of the invention, the second hole is punched through only one of the two or more credit card sized cards.

In accordance with another embodiment of a method of removably fastening together two or more credit card sized cards, a hole punch configured for concurrently punching two or more holes at predetermined positions is provided. The hole punch includes alignment guides for removably receiving one of the credit card sized cards in a predetermined position. As such, the desired number of holes are punched concurrently through the credit card sized card received in the punch.

### BRIEF DESCRIPTION OF THE DRAWINGS

FIG. 1 is a perspective view of a plurality of credit card sized cards removably fastened together in accordance with an embodiment of the invention;

FIG. 2A illustrates a guide sleeve for removably receiving a credit card sized card for punching a hole in the card in accordance with an embodiment of the invention;

FIG. 2B illustrates a single hole punch for punching the hole in the credit card sized card removably received in the guide sleeve of FIG. 2A;

FIG. 2C illustrates a plurality of different sized fasteners for removably fastening together two or more cards in accordance with the embodiments of the instant invention;

FIG. 2D illustrates one of the different sized fasteners of FIG. 2C in an unassembled state;

FIG. 2E illustrates the fastener of FIG. 2D in an assembled state;

FIG. 3 illustrates an alternate embodiment of a single hole punch having an alignment guide for punching a hole through a credit card sized card;

FIG. 4A illustrates a plurality of credit card sized cards removably fastened together with a fastener and having a second hole;

FIG. 4B illustrates alternate means for removably fastening together the credit card sized cards of FIG. 4A;

FIG. 5 illustrates an embodiment of the invention configured as a money clip; and

FIGS. 6A-6G illustrate a sequence of steps for a method of removably fastening together two or more credit card sized cards in accordance with an embodiment of the invention.

### DETAILED DESCRIPTION

While multiple embodiments are disclosed herein, still others may become apparent to one skilled in the art. In the following, certain illustrative and non-limiting embodiments are described in detail with reference to the accompanying drawings wherein like elements are designated by like numerals. It should be clearly understood that there is no intent, implied or otherwise, to limit the invention in any form or manner to that described herein. As such, all alternative embodiments are considered as falling within the spirit, scope and intent of the disclosure. The metes and bounds of the invention is defined by the appended claims and any and all equivalents thereof.

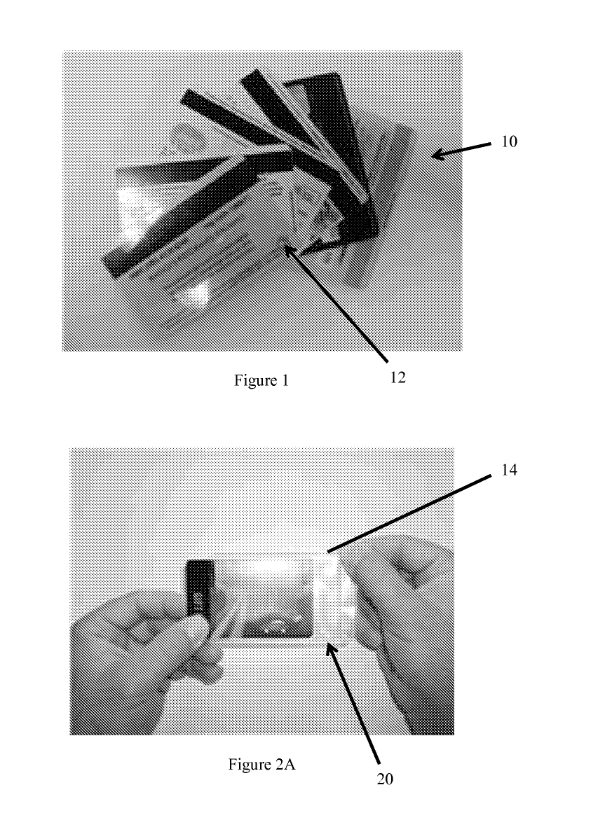

FIG. 1 is a perspective view of a plurality of credit card sized cards 10 removably fastened together by fastener 12 in accordance with an embodiment of the invention. Embodiments of the kits and method of consistently punching a hole in substantially the same predetermined position on a credit card sized card and for removably fastening together two or more credit card sized cards with a fastener, as illustrated in FIG. 1, are described herein below. The fasteners are configured for being un-fastened or dis-assembled for adding one or more cards, removing one or more cards, shuffling or re-arranging the order of the cards, etc., and then removably re-fastened together using the same or a different sized (longer or shorter) fastener.

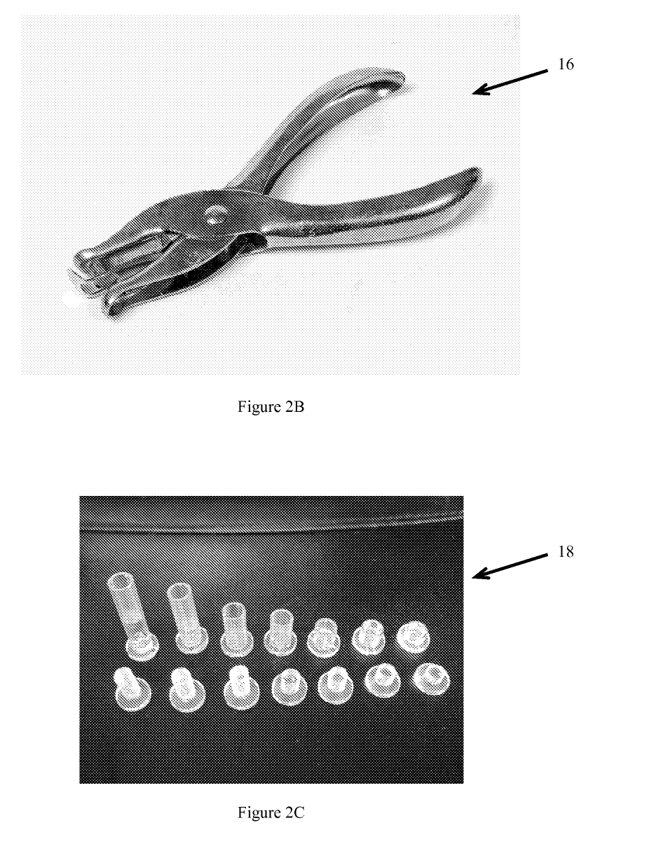

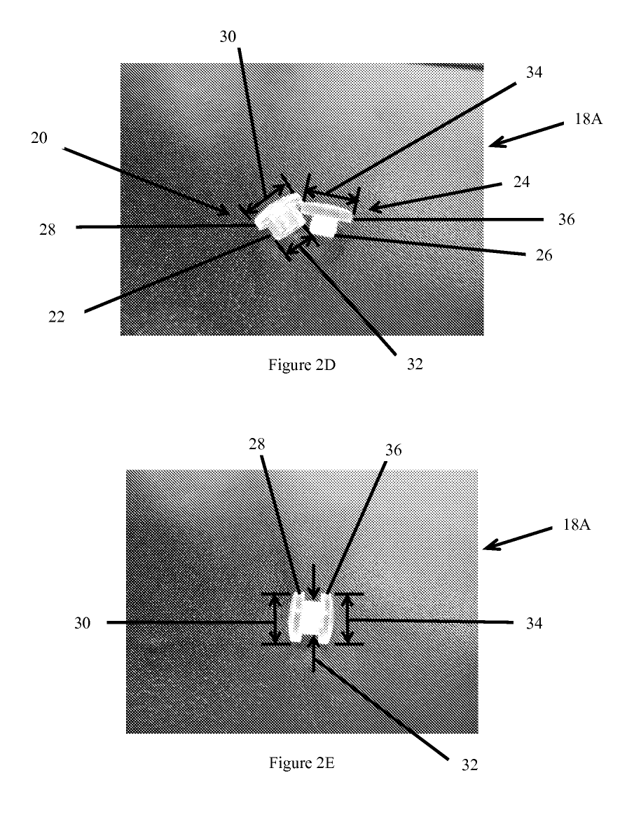

FIGS. 2A-2E illustrate an embodiment of a kit for punching a hole through a credit card sized card and thereafter removably fastening together two or more such cards. The kit includes: (i) guide sleeve 14 for removably receiving and temporarily holding at least one credit card sized card through which a hole is to be punched, (ii) single hole punch 16 for punching a hole through the credit card sized card received in guide sleeve 14; and (iii) one or more fasteners 18 for removably fastening together two or more credit card sized cards through which a hole has been punched.

In some embodiments of the kit, guide sleeve 14 includes pre-drilled guide hole 20 in a predetermined position for ensuring that a hole through every credit card sized card is consistently punched at substantially the same predetermined position. In other embodiments of the kit, guide hole 20 is not pre-drilled in guide sleeve 14. In such embodiments, guide hole 20 is created either before guide sleeve 14 is used for the first time for punching a hole in a card or concurrently with punching a hole in a card received within guide sleeve 14 when guide sleeve 14 is used for the first time. Once the credit card sized card is received within guide sleeve 14, single hole punch 16 is used for punching a hole through the card at the predetermined position where guide hole 20 is located.

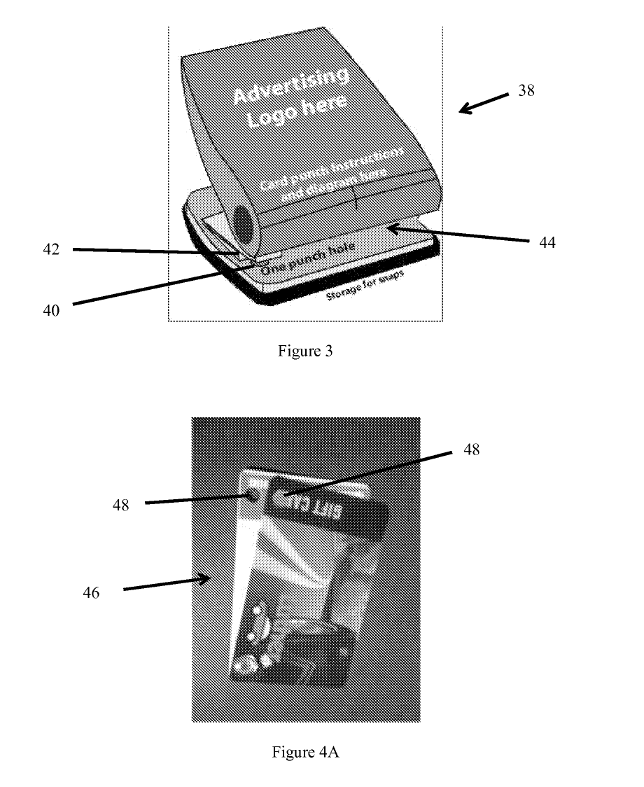

Single hole punch 16, such as that shown in FIG. 2B, are well known in the art and therefore not described herein in the interest of brevity. An alternate embodiment for a single hole punch having an alignment guide for punching a hole through a credit card sized card is described herein below with reference to FIG. 3.

It is envisioned that each kit of the instant invention will include one or more fastener 12 configured for removably fastening together two or more credit card sized cards 10. FIG. 2C illustrates a plurality of different sized fasteners 18 included in an embodiment of the kit of the instant invention. Each one of the plurality of fasteners 18 are configured substantially similar to one another, the primary difference being their respective size (or length) for accommodating a different number of credit card sized cards. Therefore, in the interest of brevity, only one fastener 18A from the plurality of fasteners 18 is described herein below.

FIGS. 2D and 2E, respectively, illustrate fastener 18A in a disassembled state and an assembled state. Fastener 18A, in an embodiment of the kit of the instant invention, includes first portion 20 having first connector portion 22 and second portion 24 having second connector portion 26. At least one of first and second portions 20 and 24, respectively, is configured for being removably inserted through the punched hole in each one of two or more credit card sized cards. Furthermore, first and second connector portions 22 and 26, respectively, are configured for being removably connected together. As such, after first or second portion 20 or 24 has been inserted through the punched hole in each of the two or more cards, first and second connector portions 22 and 26 are connected together for removably fastening the cards together. Accordingly, in an embodiment of the fastener 18A, first and second connector portions 22 and 26, respectively, are mating female and male connectors, for example a threaded boss and a bolt as described herein below. As will be apparent, such an assembly is configured for removably fastening together the two or more credit card sized cards such that the fastener can be un-fastened or dis-assembled for adding one or more cards, removing one or more cards, shuffling or re-arranging the order of the cards, etc., and then removably re-fastened together using the same or a different sized (longer or shorter) fastener. The fasteners are further configured for permitting the cards to rotate relative to one another. Therefore, it is advantageous for the hole punched through the cards to have a diameter slightly greater than the outside diameters of the first and second portions 20 and 24, respectively. It is also advantageous for each one of first and second portions 20 and 24, respectively, to include a flange or a washer at an end thereof such that the two or more credit card sized cards are sandwiched between the flanges.

In some embodiments of the invention, first portion 20 is a threaded boss and second portion 24 is a bolt. The threaded boss and the bolt are configured as mating female and male pieces such that the threaded shank of the bolt, i.e., second connector portion 26, is removably receivable within the threaded boss, i.e., first portion 20. In other words, the threaded boss and the bolt have substantially identical pitch (or thread). As shown, the threaded boss includes flange 28 at an end thereof, wherein diameter 30 of flange 28 is greater than external diameter 32 along a longitudinal extent of the threaded boss. In accordance with an embodiment of the invention, diameter 30 of flange 28 and diameter 34 of bolt head 36 are greater than a diameter of the hole punched through the credit card sized cards; and external diameter 32 is less than the diameter of the hole punched through the credit card sized cards. As such, and in accordance with an embodiment of a method described herein below, two or more credit card sized cards are removably fastened together by inserting the longitudinal extent of the threaded boss or the shank of the bolt through the punched hole in each credit card, and thereafter securing the bolt to the threaded boss. As will be evident, the differences in the diameters of the punched holes and the threaded boss enable the two or more credit card sized cards sandwiched between flange 28 and bolt head 36 to rotate relative to one another. Furthermore, the fastener is configured for being un-fastened or dis-assembled for adding one or more cards, removing one or more cards, shuffling or re-arranging the order of the cards, etc., and then removably re-fastened together using the same or a different sized (longer or shorter) fastener.

FIG. 3 illustrates an embodiment of single hole punch 38 configured for removably receiving a credit card sized card in a predetermined position and punching a hole through the card at a predetermined position on the card. Accordingly, in an alternate embodiment of the invention, the kit for punching a hole through a credit card sized card and thereafter removably fastening together two or more such cards includes: (i) single hole punch 38; and (ii) one or more fasteners 18 for fastening together two or more credit card sized cards through which a hole has been punched.

As can be seen, single hole punch 38 in accordance with an embodiment of the invention, is similar to, though not the same as, a conventional two-hole (or filebinder) punch. In contrast to the conventional two-hole punch, single hole punch 38 includes one blade 40 and a corresponding guide hole (versus two in the conventional two-hole punch) for punching the hole through the credit card sized card. As illustrated, alignment guides 42 are provided for ensuring that the credit card sized card is located at a predetermined position and properly aligned with blade 40 for consistently punching the hole at substantially the same predetermined position on each card. Single hole punch 38 also includes slot or recess 44 through which an edge of the credit card sized card extends and abuts with a portion of alignment guides 42 such that at least a portion of the credit card sized card proximate the edge is positioned under blade 40. As will be apparent, single hole punch 38 eliminates the need for including guide sleeve 14 and single hole punch 16 in the kit. A fastener, e.g., fastener 18A, is used for fastening together two or more credit card sized cards as previously described.

Although not shown, some embodiments of hole punch 38 include two or more blades, such as blade 40, for punching as many holes through the credit card sized card extending into slot 44. In other embodiments of the invention, guide sleeve 14, guide hole 20 and single hole punch 16 are used for punching one or more additional holes through the credit card sized cards. Accordingly, some embodiments of guide sleeve 14 include one or more additional guide holes, e.g., guide hole 20, for consistently punching holes at substantially same predetermined positions on a credit card sized card. As previously described with reference to FIG. 2A, the one or more guide holes in some embodiments of the invention either are pre-drilled in guide sleeve 14 or are punched when guide sleeve 14 is used for the first time.

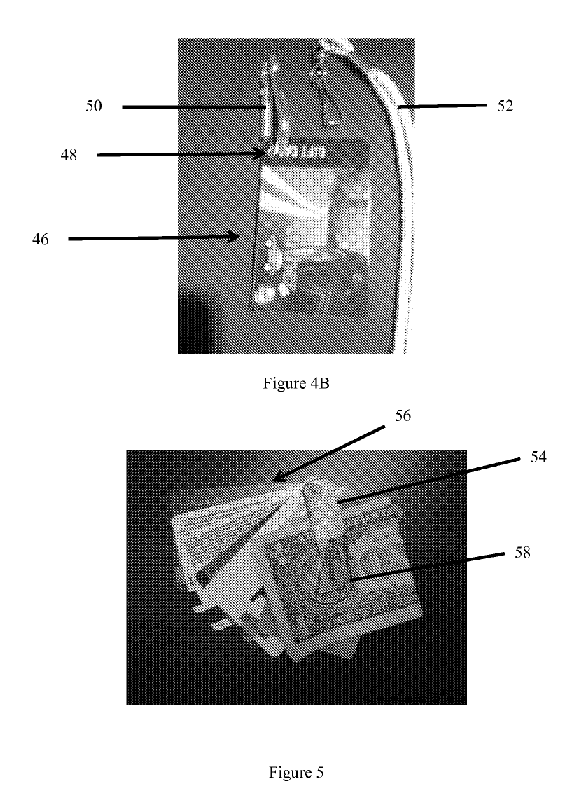

FIG. 4A illustrates an embodiment of the invention wherein two or more credit card sized cards 46 are removably fastened together with one of fasteners 18, e.g., fastener 18A, as previously described, and the cards further include second hole 48 punched therethrough at a second predetermined position. As illustrated in FIG. 4B, a device or mechanism such as carabiner 50, lanyard 52, hitch knot (not shown), etc., extends through second hole 48 and functions as an alternate means for removably fastening and carrying together two or more credit card sized cards 46 when it is not desirable or convenient to carry them in a wallet, purse, pocket, etc.

In view of the foregoing description in reference to FIGS. 4A and 4B, it will become apparent that the two or more cards can be removably fastened or held together without using one of fasteners 18. Specifically, in an alternate embodiment of the invention, the two or more credit card sized cards 46 are removably held together with a device or mechanism such as carabiner 50, lanyard 52, hitch knot (not shown), etc., extending through at least one punched hole in each card. Accordingly, in one such arrangement, it may not be necessary and/or desirable to punch second hole 48 through the one or more cards 46.

FIG. 5 illustrates an embodiment of the invention configured for securely holding (or carrying) items such as paper currency with the two or more credit cards removably fastened together with a fastener. Accordingly, some embodiments of the kit include one or more substantially rigid, though slightly flexible, clips 54 that can be removably fastened together, as illustrated, with the two or more credit card sized cards 56. In some embodiments, clip 54 is a metal (e.g., stainless steel, silver, gold, titanium, platinum, etc.), a composite (e.g., carbon fiber), a plastic, etc. As will be appreciated, one of the functional requirements of clip 54 is that it provide a snug (or tight) fit between its tip or edge 58 and outer most card 60 such that any item(s) placed therebetween is held securely. While some embodiments of clip 54 have a slight bend for this purpose, this does not always have to be the case.

FIG. 5 illustrates an embodiment configured with one money clip adjacent one of the two outermost credit card sized cards, e.g., card 60, removably fastened together with one of fasteners 18, e.g., fastener 18A. As such, the other outermost card that does not have a money clip adjacent thereto will be substantially similar to that illustrated in FIG. 1. Alternate embodiments of the invention are configured with two money clips, wherein one money clip is adjacent one of the two outermost credit card sized cards and the second money clip is adjacent the other of the two outermost credit card sized cards removably fastened together with one of fasteners 18. Certain embodiments of the invention are configured with a money clip between the two outermost credit card sized cards removably fastened together with one of fasteners 18. Other embodiments of the invention having additional money clips or fewer money clips or no money clip are considered as being within the scope of the instant invention. As previously described, the fastener is configured for being un-fastened or dis-assembled for adding one or more cards and/or clips, removing one or more cards and/or clips, shuffling or re-arranging the order of the cards and/or clips, etc., and then removably re-fastened together using the same or a different sized (longer or shorter) fastener.

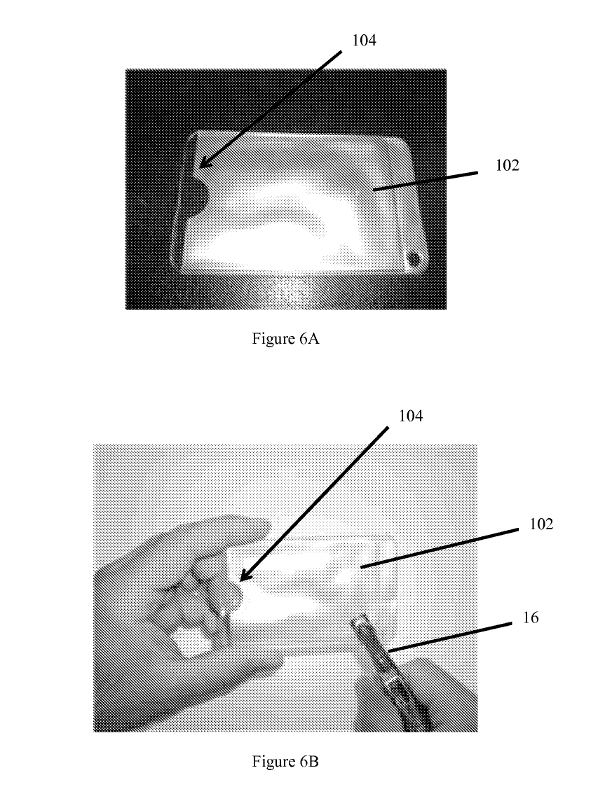

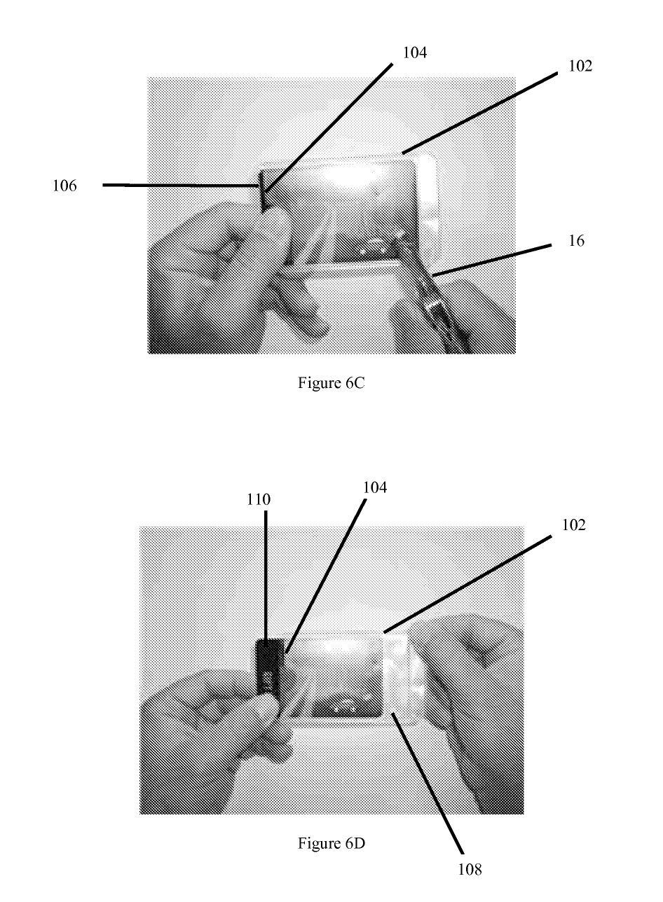

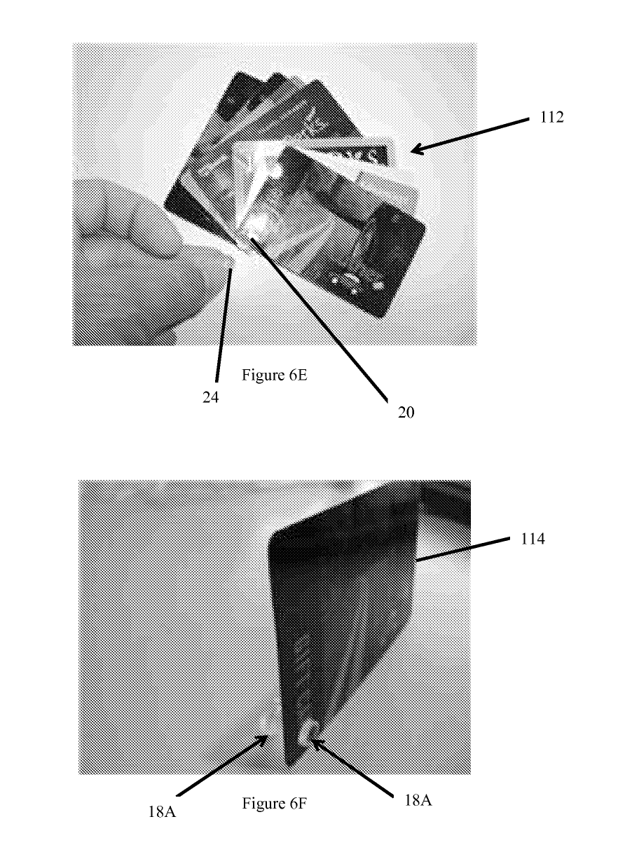

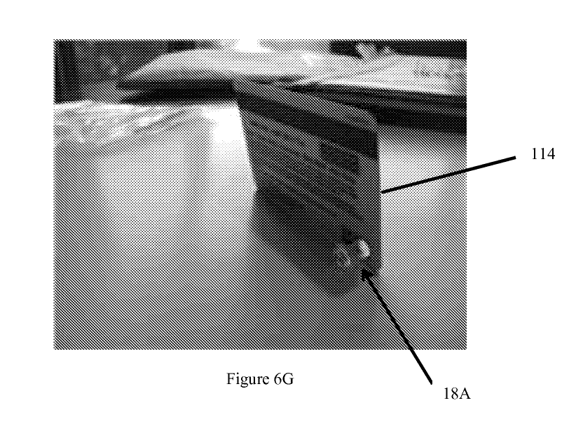

FIGS. 6A-6G illustrate a sequence of steps for an embodiment of a method of removably fastening together two or more credit card sized cards. FIG. 6A illustrates an embodiment of guide sleeve 102 included in an embodiment of a kit of the instant invention. Guide sleeve 102 includes opening 104, and is configured for removably receiving and temporarily holding a credit card sized card inserted therein through opening 104. As shown, guide sleeve 102 is devoid of a guide hole that can be used as a guide for punching a hole at a predetermined position on the credit card sized card received therewithin. As illustrated in FIG. 6B, single hole punch 16 is used for punching a guide hole at a predetermined position through guide sleeve 102 before guide sleeve 102 is used for the first time for punching a hole through a credit card sized card. In an alternate embodiment, single hole punch 38 is used for punching the guide hole through guide sleeve 102 before using it for the first time. As previously described with reference to FIG. 2A, the guide hole is pre-drilled in some embodiments of guide sleeve 102, e.g., guide hole 20 in guide sleeve 14 in FIG. 2A.

Alternatively, as illustrated in FIG. 6C, when guide sleeve 102 is devoid of a pre-drilled guide hole and is used for the first time, credit card sized card 106 is first positioned within guide sleeve 102 through opening 104, and single hole punch 16 is used for punching a hole at a predetermined position through both guide sleeve 102 and credit card sized card 106 positioned therewithin. In an alternate embodiment, single hole punch 38 is used for punching a hole at a predetermined position through both guide sleeve 102 and credit card sized card 106 positioned therewithin. Credit card sized card 106, now configured for fastening together with other cards having similar holes, is then removed from guide sleeve 102. Guide sleeve 102 having either a pre-drilled or punched guide hole, e.g., guide hole 108 in FIG. 6D, is now configured for consistently punching a hole through additional credit card sized cards at substantially the same predetermined position.

As illustrated in FIG. 6D, credit card sized card 110 devoid of a hole therethrough is placed within guide sleeve 102 through opening 104 and appropriately positioned within guide sleeve 102. Then, guide hole 108 is used as a guide for punching a hole through card 110 at a predetermined position using single hole punch 16 or 38. After at least one hole has been punched through two or more credit card sized cards, the cards are stacked with their holes aligned and are fastened together using one of fasteners 18. By way of an example, FIG. 6E illustrates first portion 20 of fastener 18A is inserted from the top of the stack of credit card sized cards 112 and through the aligned holes. Next, second portion 24 of fastener 18A is inserted from the bottom of the stack of cards 112 and through the aligned holes. First and second connector portions 22 and 26 are then removably connected together. As will be apparent, these are not the only sequential step in which credit card sized cards 112 are fastened together with one of fasteners 18.

For illustration purposes only, FIGS. 6F and 6G, respectively, show exemplary front and rear views of cards, wherein one of fastener 18, e.g., assembled fastener 18A, is shown removably attached to (or removably extending through a hole in), this example, one credit card sized card 114.

As will be apparent from the foregoing, one or more clips, e.g., clip 54, can also be removably fastened together with the two or more credit card sized cards for providing a configuration that also functions as a money clip such as that illustrated in FIG. 5. This is accomplished by aligning a hole in clip 54 with the holes in the stack of card prior to inserting any portions of one of fastener 18 through the aligned holes.

As previously described with reference to FIGS. 4A and 4B, it may sometimes be desirable to punch two or more holes through credit card sized cards 46. Second hole 48 can be punched through a credit card sized card at a predetermined positioned in accordance with one of several steps. For example, after a first hole has been punched through the card, the card can be removed from the guide sleeve, rotated 180 degrees about an axis parallel to the short length of the card, reinserting and repositioning the card within the guide sleeve, and using single hole punch 16 for punching second hole 48 through the card. Alternatively, the guide sleeve may include two guide holes at predetermined positions and single hole punch 16 is used for punching the first and second holes through a card appropriately positioned within the guide sleeve.

In other embodiments, a method of punching at least two holes through a credit card sized card includes the steps of: inserting the card in single hole punch 38 at a predetermined position and punching a first hole through the card, removing the card from single hole punch 38, rotating the card 180 degrees about an axis parallel to the short length of the card, reinserting and repositioning the card within single hole punch 38, and punching second hole 48 through the card. In another embodiment, a method of punching at least two holes through a credit card sized card includes the steps of: appropriately positioning the card in a two hole punch similar to single hole punch 38 but including two blades such as blade 40 and concurrently punching both holes through the card at their respective predetermined positions.

If desired, the various embodiments of a method of punching second hole 48 further includes the step of attaching a device or mechanism such as carabiner 50, lanyard 52, hitch knot (not shown), etc., extends through second hole 48.

From the foregoing, it should be apparent that the one or more holes punched through a credit card sized card will not extend through any media located on or within the card that contains vital information necessary for using the card. Such media include, but are not limited to, one or more readable for example as a magnetic strip, radio frequency identification means, memory, chip, etc.

As will be apparent from the foregoing, the credit card sized cards are removably fastened together by one of fastener 18. Accordingly, the number of cards and/or clips removably fastened together can be increased or decreased by changing the fastener to one of an appropriate length (or size). For instance, an existing fastener can be dis-assembled or removed, one or more cards added to the stack of cards, and a longer fastener used for removably re-fastening together the now thicker stack of cards. Similarly, an existing fastener can be dis-assembled or removed, one or more cards removed from the stack of cards, and a shorter fastener used for removably re-fastening together the now thinner stack of cards. Also, an existing fastener can be dis-assembled or removed, one or more cards re-arranged or shuffled, and the fastener used for removably re-fastening together the stack of cards. As will be apparent, the same can be done for one or more clips or any other item desired to be removably fastened together with the two or more credit card sized cards.

As will be apparent from the foregoing, it is advantageous for configuring fasteners 18 and the one or more holes in a credit card sized card such that the cards, when fastened together with one of fastener 18, are rotatable relative to one another. This enables the user to separate or segregate one or more cards from the others. For instance, a bank ATM card or a charge card can be separated from all the other cards such that associated media, e.g., a magnetic strip, can be easily used.

While the foregoing description of the invention primarily references removably fastening together two or more credit card sized cards, it should be apparent that the embodiments of the kits and/or methods, and any alternatives thereof, are also applicable for removably fastening together objects other than credit cards and/or objects sized differently from a credit card. Such exemplary objects include, but are not limited to, one or more of sample cards, e.g., for paint, formica, etc., coupons, business cards, etc.

In some embodiments of the invention, fasteners 18 and/or one or more clips 54 include one or more indicia. The indicia can be the owner's name and/or other identifying information, a decorative indicia, a sports team decal, a logo, etc.

Various modifications may become apparent based on the above detailed description of certain non-limiting exemplary embodiments without departing from the spirit, scope and intent of the invention. For example, while the described embodiments refer to particular features and/or functions, the invention is considered to also include embodiments having combinations of features and/or functions different from those described. Accordingly, the scope and intent of the invention is intended to embrace all such alternatives, modifications, variations, etc., as may become apparent to one skilled in the art. The metes and bounds of the invention is defined by the appended claims and any and all equivalents thereof.

What is claimed is:

1. A kit for removably fastening together two or more credit card sized cards, comprising:
a guide sleeve for removably receiving and temporarily holding one of the credit card sized cards;
a hole punch for punching a hole through one of the two or more credit card sized cards or the guide sleeve; and
a fastener configured for removably fastening together the two or more credit card sized cards at holes created by the hole punch, the fastener, when removably fastening the two or more credit card sized cards together, configured to permit the two or more credit card sized cards to rotate relative to each other.

2. The kit of claim 1, comprising a clip having a hole therethrough and configured for being removably fastened together with the two or more credit card sized cards, thereby forming a money clip.

3. The kit of claim 1, wherein said fastener is one or more of a carabiner, lanyard, hitch knot, or any combination thereof.

4. The kit of claim 1, wherein said fastener comprises a flanged threaded boss and a mating bolt.

5. The kit of claim 1, wherein said fastener comprises:
a first portion with a first connector portion;
a second portion with a second connector portion; and
at least one of the first portion and the second portion being removably insertable through the holes in the two or more credit card sized cards, the first and second connector portions being removably connectable together, the first and second connector portions configured to removably fasten the two or more credit card sized cards together while permitting the two or more credit card sized cards to rotate relative to each other when the first and second connector portions are removably connected together and when the at least one of the first portion and the second portion is removably inserted through the hole in the two or more credit card sized cards.

6. The kit of claim 1, wherein said fastener is configured for being un-fastened or dis-assembled for one or more of adding one or more cards and/or clips, removing one or more cards and/or clips, shuffling or re-arranging the order of one or more cards and/or clips, or any combination thereof, and then removably re-fastening the two or more cards and/or clips together using the same or a different sized (longer or shorter) fastener.

7. A kit for removably fastening together two or more credit card sized cards, comprising:
a hole punch having alignment guides for removably receiving one of the credit card sized cards in a predetermined position, the hole punch configured for punching a hole through one of the two or more credit card sized cards in a consistent position while the one of the credit card sized cards is received in the hole punch in the predetermined position; and
a fastener configured for removably fastening together the two or more credit card sized cards at holes created by the hole punch, the fastener, when removably fastening the two or more credit card sized cards together, configured to permit the two or more credit card sized cards to rotate relative to each other.

8. The kit of claim 7, comprising a clip having a hole therethrough and configured for being removably fastened together with the two or more credit card sized cards, thereby forming a money clip.

9. The kit of claim 7, wherein said fastener comprises a flanged threaded boss and a mating bolt.

10. The kit of claim 7, wherein said fastener comprises:
a first portion with a first connector portion;
a second portion with a second connector portion; and
at least one of the first portion and the second portion being removably insertable through the holes in the two or more credit card sized cards, the first and second connector portions being removably connectable together, the first and second connector portions configured to removably fasten the two or more credit card sized cards together while permitting the two or more credit card sized cards to rotate relative to each other when the first and second connector portions are removably connected together and when the at least one of the first portion and the second portion is removably inserted through the hole in the two or more credit card sized cards.

11. The kit of claim 7, wherein said fastener is configured for being un-fastened or dis-assembled for one or more of adding one or more cards and/or clips, removing one or more cards and/or clips, shuffling or re-arranging the order of one or more cards and/or clips, or any combination thereof, and then removably re-fastening the two or more cards and/or clips together using the same or a different sized (longer or shorter) fastener.

12. A method of removably fastening together two or more credit card sized cards, comprising:
punching a hole in a guide sleeve at a location defined as the guide sleeve hole, the guide sleeve configured for removably receiving and temporarily holding one of the credit card sized cards;
inserting each one of the credit card sized cards in the guide sleeve, with only one card in the guide sleeve at any one time;
punching a hole in the one of the credit card sized cards while in the guide sleeve at the guide sleeve location;
removing each one of the credit card sized cards from the guide sleeve after punching a hole in the one of the credit sized credit cards; and
removably fastening together each one of the credit card sized cards via the holes punched in the cards via a fastener configured to permit the two or more credit card sized cards to rotate relative to each other when removably fastening the cards together.

13. The method of claim 12, further comprising:
punching a second hole in at least one of the credit sized credit cards; and
attaching the removably fastened together credit sized credit cards to a carabiner, lanyard, or shoe lace extending through said second hole to facilitate transport of the removably fastened together credit sized credit cards.

14. The method of claim 13, further comprising
punching a second hole in the guide sleeve at a location defined as the guide sleeve second hole,
wherein the punching the second hole in at least one of the credit sized credit cards occurs while the at least one of the credit card sized cards is in the guide sleeve; and
wherein the punching the second hole in at least one of the credit sized credit cards is at the guide sleeve second hole.

15. The method of claim 12, wherein said guide sleeve comprises one or more pre-drilled holes.

16. The method of claim 12, comprising
unfastening or disassembling said fastener;
adding and/or removing and/or re-arranging one or more cards and/or clips; and
removably refastening the two or more cards and/or clips together using the same or a different length fastener.

17. A method of removably fastening together two or more credit card sized cards, comprising:
providing a hole punch having alignment guides for removably receiving one of the credit card sized cards in a predetermined position, the hole punch configured for punching a hole through one of the two or more credit card sized cards in a consistent position while the one of the credit card sized cards is received in the hole punch in the predetermined position;
punching said hole through the one of the credit card sized card received in the hole punch;
providing a fastener configured for removably fastening together the two or more credit card sized cards at holes created by the hole punch, the fastener, when removably fastening the two or more credit card sized cards together, configured to permit the two or more credit card sized cards to rotate relative to each other; and
removably fastening together the two or more credit card sized cards.

18. The method of claim 17, comprising
unfastening or disassembling said fastener;
adding and/or removing and/or re-arranging one or more cards and/or clips; and
removably re-fastening the two or more cards and/or clips together using the same or a different sized (longer or shorter) fastener.

19. A fastener for removably fastening together two or more credit card sized cards, comprising:
a first portion with a first connector portion;
a second portion with a second connector portion; and
at least one of the first portion and the second portion being removably insertable through a hole in the two or more credit card sized cards, the first and second connector portions being removably connectable together, the first and second connector portions configured to removably fasten the two or more credit card sized cards together while permitting the two or more credit card sized cards to rotate relative to each other when the first and second connector portions are removably connected together and when the at least one of the first portion and the second portion is removably inserted through the hole in the two or more credit card sized cards.

20. The fastener of claim 19, wherein the fastener includes decorative indicia.

21. The fastener of embodiment 19, wherein the first and second connector portions comprise mating male and female connector portions.
